(19) United States
(12) Patent Application Publication
(10) Pub. No.: US 2026/0168605 A1
(43) Pub. Date: Jun. 18, 2026

(54) FEMALE FLUIDIC CONNECTOR ELEMENT AND ASSOCIATED FLUIDIC CONNECTOR

(71) Applicant: STAUBLI FAVERGES, Faverges-Seythenex (FR)

(72) Inventors: Olivier Poly, Val de Chaise (FR); Sean Bonnefoy, Chainaz-les-Frasses (FR); Christophe Durieux, Gilly sur Isere (FR)

(21) Appl. No.: 19/408,878

(22) Filed: Dec. 4, 2025

(30) Foreign Application Priority Data
Dec. 18, 2024 (FR) 2414509

(51) Int. Cl. F16L 37/086; F16L 37/40

(52) U.S. Cl. CPC F16L 37/086; F16L 37/40

(57) ABSTRACT

This female element, which provides an internal channel, comprises a main body and an adapter rotatable relative to the main body. The main body provides a distal opening intended to receive a male fitting. The adapter comprises a proximal part, connectable to a pipeline, and a distal part with a tubular portion by which the adapter is fitted into a bore of the main body. A seal support, which is received in the internal channel, supports a first seal between the seal support and an inner surface of the tubular portion, and a second seal, which is intended to ensure a seal between the seal support and the male fitting in the connected position, the seal support being free in rotation relative to the main body.

### FIELD

The present invention relates to a female fluidic connector element, as well as a fluidic connector comprising such a female element.

### BACKGROUND

This concerns fluidic connectors allowing the quick connection of a first fluid line, provided with a female element, to another fluid line provided with a complementary male fitting. Such a fluidic connector is also called a “quick connector.” The male fitting has a cylindrical tubular end with a locking collar, while the female element comprises a lock, for example, a button, which the user must press to disconnect the female element from the male fitting. The fluidic connector is then called a “button connector.”

The female element generally comprises a main body, which is provided with the locking button, and an adapter, also called a “shutter,” which is attached to the first fluid line. The main body is assembled to the adapter. When the first fluid line is fixed, it may be necessary to be able to rotate the main body relative to the shutter so that the button is more easily accessible to the user.

U.S. Pat. No. 5,209,262 describes, for example, a female fluidic connector element, wherein the main body is orientable relative to the adapter. A distal end of the shutter penetrates into a bore of the main body. A deformable rod 86 is introduced through an opening in the body, into a housing defined by circumferential grooves made in the body and the shutter. A seal is placed between the main body and the adapter. However, with each pivoting maneuver of the main body relative to the adapter, the seal rubs and tends to wear, risking leaks. Moreover, the friction of the seal contributes to a resistance torque to the rotation of the main body relative to the shutter. This torque will therefore evolve with the wear of the seal following the different maneuvers.

The invention aims to particularly address these problems by proposing a female fluidic connector element with improved reliability, and presenting a resistance torque to the rotation of the main body relative to the shutter that is easily determinable and stable.

### SUMMARY

To this end, the invention concerns a female fluidic connector element, the female element being intended to be connected to a male fitting, the male fitting comprising an end with a first cylindrical part and a locking collar, the female element comprising:
a main body, which provides a first passage extending along a longitudinal axis, the main body comprising a distal portion and a proximal portion, which are aligned along the longitudinal axis, the first passage opening from the distal portion through a distal mouth, the main body being configured to receive the male fitting in the first passage through the distal mouth,
a lock, which is assembled to the distal portion and is movable between:
a first seal, which is interposed between the seal support and an inner surface of the tubular portion of the adapter, to ensure a seal between the seal support and the adapter,
a second seal, which is arranged in the internal passage and is intended to ensure a seal between the seal support and the male fitting in the connected position,
the seal support is received in the internal channel being free in rotation relative to the main body of the female element in an assembled configuration.

By means of the invention, the seal support ensures sealing with the adapter—by the first seal—and the male fitting—by the second seal—while being free in rotation relative to the main body. Thus, the main body can be angularly oriented relative to the adapter, without the first seal rubbing against the inner surface of the tubular part of the shutter. The rotation torque to be applied by the user is independent of the first seal and is thus essentially determined by the structure of the assembly of the adapter with the main body, by means of the axial locking element. Thus, the rotation torque to be applied remains stable. Moreover, the wear of the first seal is reduced, which contributes to the longevity and reliability of the female fluidic connector element.

According to advantageous but non-mandatory aspects of the invention, such a female element can incorporate one or more of the following features taken individually or in any technically permissible combination:
The bore of the proximal portion comprises:
a first cylindrical portion, which has a first internal diameter and is intended to receive the tubular portion of the adapter,
a second cylindrical portion, which has a second internal diameter, the second internal diameter being smaller than the first internal diameter,
a third cylindrical portion, which has a third internal diameter, the third internal diameter being smaller than the second internal diameter,
a stop wall, which extends in a plane perpendicular to the longitudinal axis between the second cylindrical portion and the third cylindrical portion,
while the seal support comprises:
a proximal part, which has a first external diameter and wherein a first groove for receiving the first seal is provided, and
an intermediate part, which has a second external diameter, the second external diameter being larger than the first external diameter, the intermediate part being housed in the second cylindrical portion of the bore.
The distal portion of the main body provides an orifice, which extends along a locking axis radial to the longitudinal axis, and which opens into the first passage,
while the lock comprises a locking portion, which is received in the orifice and wherein an opening is provided to receive the male fitting,
that the lock is movable in translation relative to the main body along the locking axis, the locking position and the unlocking position being two axial positions along the locking axis,
and that the female element comprises a stop washer, which is received in the internal channel between the lock and the seal support, the stop washer comprising:
a protrusion, which extends into the opening of the lock and is intended to allow the movements of the lock between the locking position and the unlocking position, while preventing movements beyond the locking position and,
a guide surface, which is intended to guide the first cylindrical part of the male fitting from the opening of the lock to the internal passage of the seal support.
The bore of the proximal portion of the main body comprises:
a first cylindrical portion, which has a first internal diameter and is intended to receive the tubular portion of the adapter,
a second cylindrical portion, which has a second internal diameter, the second internal diameter being smaller than the first internal diameter,
a third cylindrical portion, which has a third internal diameter, the third internal diameter being smaller than the second internal diameter,
a stop wall, which extends in a plane perpendicular to the longitudinal axis between the second cylindrical portion and the third cylindrical portion,
while the stop washer is axially supported against the stop wall and centered in the third cylindrical portion.
The seal support and the stop washer form a single piece.
The seal support and the stop washer form two distinct pieces, while the seal support comprises a distal wall, which is oriented towards the stop washer and on which a circular boss is provided, and the stop washer is axially supported against the distal wall of the seal support by means of the circular boss.
The seal support and the stop washer form two distinct pieces, while the seal support comprises a distal wall, which is oriented towards the stop washer, and the stop washer comprises a proximal face, on which a circular boss is provided in axial support against the distal wall of the seal support.
the female element comprises:
a valve, which is received in the internal channel and is movable in translation along the longitudinal axis between a forward position, wherein the valve closes the fluid flow through the internal channel, and a rearward position, wherein the fluid flow through the internal channel is not prevented, and
a valve spring, which is configured to return the valve from the rearward position to the forward position, the valve being configured to be pushed into the rearward position, against the valve spring, by the end of the male fitting in the connected position.
The valve is arranged on a side opposite the distal mouth of the main body relative to the second seal, the valve comprising:
a distal part, which is received in the internal passage of the seal support when the valve is in the closed position and by means of which the valve is pushed into the open position by the end of the male fitting in the connected position, and
an axial stop, which extends radially to the longitudinal axis, and which has a front face, which is axially supported against the seal support when the valve is in the closed position, the axial stop having a rear face, opposite the front face,
while the valve spring is arranged between the rear face of the axial stop and the adapter.
The seal support is screwed into an internal surface of the distal part of the adapter.
The internal groove of the bore is an internal circumferential groove, while the locking element is a deformable ring, which is introduced into the locking space through a hole in the main body.
The internal groove of the bore is an internal circumferential groove, while the locking element is a plurality of balls, which are introduced into the locking space through a hole in the main body, the hole being sealed after assembly.
The bore of the main body comprises a plurality of holes, which are each intended for the passage of a respective pin, which are arranged orthoradially to the longitudinal axis and which open into the bore, the set of pin passage holes forming the internal groove, while the pins together form the locking element, each pin being introduced into the locking space through the corresponding passage hole.
The invention also relates to a fluidic connector, comprising:
an instance of the female element as described above, and
a male fitting, which comprises an end with a first cylindrical part and a locking collar,
wherein the male fitting is received in the connected position in the internal channel of the female element.

### BRIEF DESCRIPTION OF THE DRAWINGS

The invention will be better understood, and other advantages thereof will appear more clearly in light of the following description of several embodiments of a female element and a fluidic connector, in accordance with its principle, given solely by way of example and made with reference to the appended drawings, wherein:

FIG. 1 is a longitudinal section of a fluidic connector according to a first embodiment of the invention and shown in a disconnected configuration, the fluidic connector comprising a female element, also in accordance with the invention.

FIG. 2 shows, in two inserts a) and b), an exploded perspective view of the female element shown in FIG. 1, and a cross-section of the female element shown in FIG. 1, according to a plane II-II.

FIG. 3 is a longitudinal section of the fluidic connector shown in FIG. 1, shown in a coupled configuration.

FIG. 4 shows, in two inserts a) and b), a longitudinal section of a female element belonging to a fluidic connector according to a second embodiment of the invention, and a view of a detail of this female element.

FIG. 5 shows respectively, in two inserts a) and b), a longitudinal section of a female element belonging to a fluidic connector according to a third embodiment of the invention, and a view of a detail of this female element.

FIG. 6 shows respectively, in two inserts a) and b), a longitudinal section of a female element belonging to a fluidic connector according to a fourth embodiment of the invention, and a view of a detail of this female element.

FIG. 7 shows respectively, in two inserts a) and b), a longitudinal section of a female element belonging to a fluidic connector according to a fifth embodiment of the invention, and a cross-section of this female element, according to a plane VII-VII.

FIG. 8 shows respectively, in two inserts a) and b), a longitudinal section of a female element belonging to a fluidic connector according to a sixth embodiment of the invention, and a cross-section of this female element, according to a plane VIII-VIII.

### DETAILED DESCRIPTION

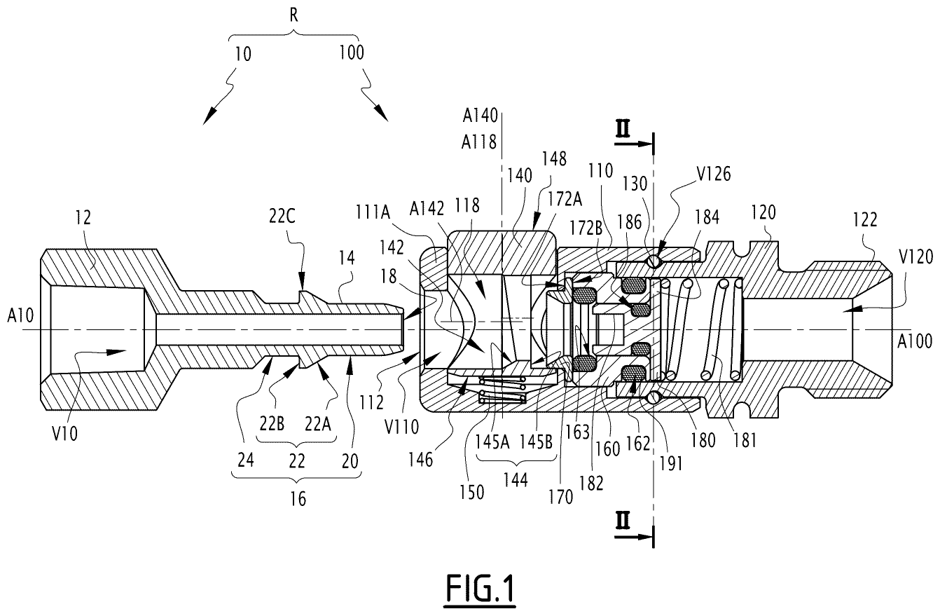

A fluidic connector R, according to a first embodiment of the invention, is described with reference to FIGS. 1 to 3. The fluidic connector R comprises a male fitting 10, which is located on the left of FIG. 1, and a female element 100, located on the right of FIG. 1. The following description is made in relation to the various elements of the fluidic connector R as shown in the figures, knowing that it may be otherwise in reality.

The fluidic connector R is shown in a disconnected configuration in FIG. 1, the male fitting 10 being located opposite the female element 100. In the disconnected configuration, for each of the elements chosen from the female element 100 and the male fitting 10, a distal side—or front side—of this element is the side closest to the other element, while a proximal side—or rear side—of this element is the side furthest from the other element. Thus, in FIG. 1 the distal side of the male fitting 10 is located on the right, opposite the female element 100, while the proximal side of the male fitting 10 is located on the left. Symmetrically, in FIG. 1 the distal side of the female element 100 is located on the left, opposite the male fitting 10, while the proximal side of the female element 100 is located on the right.

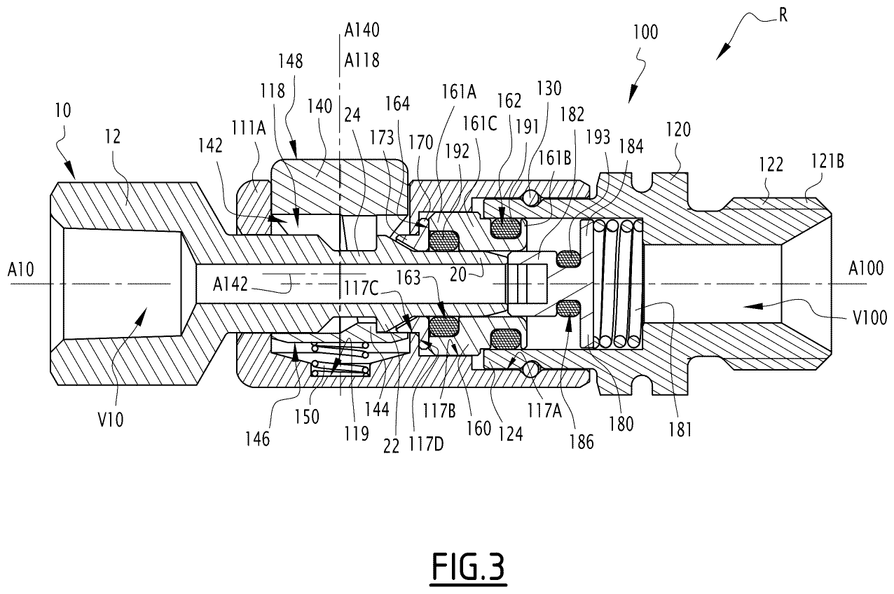

The male fitting 10, which is also simply called fitting, or sometimes “joint,” has a hollow tubular shape that provides an internal passage V10 extending along a main axis A10. The male fitting 10 comprises a proximal part 12, through which the internal passage V10 opens, and which is configured to be secured to a fluid line, for example a hose, so that the internal passage is in fluid communication with the fluid line. The fluid line is not shown. The fitting 10 comprises a distal part 14, which is intended to be received in the female element 100, the male fitting 10 then being in a connected position relative to the female element 100. The fluidic connector R is then in a connected configuration, as shown in FIG. 3.

The distal part 14 here has a shape of revolution around the main axis A10. The distal part 14 has an end 16, which provides a mouth 18 through which the internal passage V10 opens. Moving from the mouth 18 towards the proximal part 12 on an external side of the male fitting 10, the end 16 comprises:

### EXAMPLES

a first cylindrical part 20, of tubular shape,
a locking collar 22, which extends in projection relative to the first cylindrical part 20, and
a second cylindrical part 24, which is recessed from the collar 22.

In other words, the collar 22 is provided in projection relative to the second cylindrical part 24. Preferably, the second cylindrical part 24 is tubular. Preferably, the second cylindrical part 24 has a diameter equal to a diameter of the first cylindrical part 20.

The collar 22 advantageously has a frustoconical section, which diverges towards the proximal side of the male fitting 10. In the illustrated example, the collar 22 has a first face 22A, which extends the first cylindrical part 20 and which has a conical shape; and a second face called “retaining face” 22B, which is carried by a plane orthogonal to the main axis A10 and which is interposed between the first face 22A and the second cylindrical part 24. The retaining face 22B is thus an axial face. The first face 22A is thus oriented towards the distal side of the male fitting 10, while the retaining face 22B is oriented towards the proximal side of the male fitting 10. The retaining face 22B forms a rear side of the collar 22.

In the illustrated example, the conical first face 22A and the axial retaining face 22B are connected by a third cylindrical part 22C. The third cylindrical part 22C, which has a diameter larger than the diameter of the first cylindrical part 20 and the diameter of the second cylindrical part 24, thus forms a summit of the collar 22.

The female element 100 is now described.

The female element 100 extends generally along a longitudinal axis A100 and provides an internal channel V100 for fluid passage. When the fluidic connector 100 is in a connected configuration, the internal channel V100 of the female element 100 is in fluid communication with the internal passage V10 of the male fitting 10, the main axis A10 being aligned with the longitudinal axis A100.

The female element 100 comprises a main body 110, which is traversed by a first passage V110, and an adapter 120, which is traversed by a second passage V120 and which is assembled to the main body 110 in an assembled configuration of the female element 100, so that the second passage V120 is in communication with the first passage V110.

The first passage V110 extends along the longitudinal axis A100, the main body 110 comprising a distal portion 111A and a proximal portion 111B, which are aligned along the longitudinal axis A100. The first passage V110 opens from the distal portion 111A through a distal mouth 112. The main body 110 is configured to receive the male fitting 10 in the first passage V110 through the distal mouth 112. The male fitting 10 is then in the connected position relative to the female element 100.

The proximal portion 111B of the main body 110 includes a bore 114. The bore 114 has a cylindrical shape with a circular section centered on the longitudinal axis A100. The bore 114 is configured to receive a distal part 121A of the adapter 120 when the female element 100 is in the assembled configuration.

The first passage V110 is thus radially delimited by the bore 114. The proximal portion 111B has an end surface 115, which is here an axial surface, i.e., a surface carried by a plane orthogonal to the longitudinal axis A100. The proximal portion 111B comprises an internal side, which is oriented towards the longitudinal axis A100, and an external side, which is oriented opposite the internal side. The proximal portion 111B comprises an internal groove 116, which is provided recessed in the bore 114. The internal groove 116 is generally carried by a plane orthogonal to the longitudinal axis A100, in other words, the internal groove 116 is a radial groove to the longitudinal axis A100. In the first embodiment, the internal groove 116 extends over 360° around the longitudinal axis A100 and thus forms an internal circumferential groove.

Preferably, the bore 114 of the proximal portion 111B comprises, from the internal side and moving from the end surface 115 towards the distal mouth 112:
a first cylindrical portion 117A, which has a first internal diameter and is intended to receive the distal part 121A of the adapter 120,
a second cylindrical portion 117B, which has a second internal diameter, the second internal diameter being smaller than the first internal diameter,
a third cylindrical portion 117C, which has a third internal diameter, the third internal diameter being smaller than the second internal diameter,
a stop wall 117D, which extends in a plane perpendicular to the longitudinal axis A100 between the second cylindrical portion 117B and the third cylindrical portion 117C. In other words, the stop wall is an axial wall.

The adapter 120 comprises, in addition to the distal part 121A, a proximal part 121B, from which the second passage V120 opens and which includes means of securing 122 with a pipeline. The pipeline is not shown. In other words, the adapter 120 is able to be fluidically connected to a pipeline, so that the second passage V120 is in fluid communication with the pipeline.

In the non-limiting example illustrated, the securing means 122 are formed by a threaded portion. In a non-illustrated variant, the securing means have a different shape, for example, a barbed tail intended to receive a flexible hose held by a clamp, etc.

The distal part 121A of the adapter 120, by which the adapter is able to be assembled to the proximal portion 111B of the main body 110, includes a tubular portion 124. The tubular portion 124 has a cylindrical shape with a circular section, centered on the longitudinal axis A100.

The tubular portion 124 is configured to be received in the bore 114 when the female element 100 is in the assembled configuration. In other words, the bore 114 has a complementary shape to the tubular portion 124.

The second passage V120 is thus radially delimited by the tubular portion 124. The tubular portion 124 has an end surface 125, which is here an axial surface, i.e., a surface carried by a plane orthogonal to the longitudinal axis A100. The tubular portion 124 comprises an internal side, which is oriented towards the longitudinal axis A100, and an external side, which is oriented opposite the internal side. The tubular portion 124 has, on the internal side, an internal diameter. The tubular portion 124 comprises an external circumferential groove 126, which is provided recessed in the tubular portion 124, on the external side of the tubular portion 124. The external circumferential groove 126 extends over 360° around the longitudinal axis A100. The external circumferential groove 126 is generally carried by a plane orthogonal to the longitudinal axis A100; in other words, the external circumferential groove 126 is a radial groove to the longitudinal axis A100.

When the female element 100 is in the assembled configuration, the external side of the tubular portion 124 is located opposite the internal side of the bore 114, and the internal groove 116 is located opposite the external circumferential groove 126. In other words, the internal groove 116 and the external circumferential groove 126 are generally carried by the same plane. The external circumferential groove 126 and the internal groove 116 opposite define together a locking space V126. In the first embodiment, the locking space V126 has substantially a toroidal shape with a circular section, centered on the longitudinal axis A100.

A hole 128 is provided through the main body 110, the hole 128 connecting the locking space V126 to the external side of the proximal portion 111B. Preferably, the hole 128 is provided in an orthoradial direction to the longitudinal axis A100. By orthoradial direction, it is meant that the hole 128 is provided along an axis orthogonal to a radial plane to the longitudinal axis A100, a radial plane to the longitudinal axis A100 being a plane carrying the longitudinal axis A100.

The female element 100 also comprises an axial locking element 130. The axial locking element 130 is received in the locking space V126, so as to prevent translational movements of the main body 110 relative to the adapter 120 along the longitudinal axis A100, while allowing rotational movements of the main body 110 relative to the adapter 120 around the longitudinal axis A100. In other words, the kinematic connection between the main body 110 and the adapter 120 is a pivot connection.

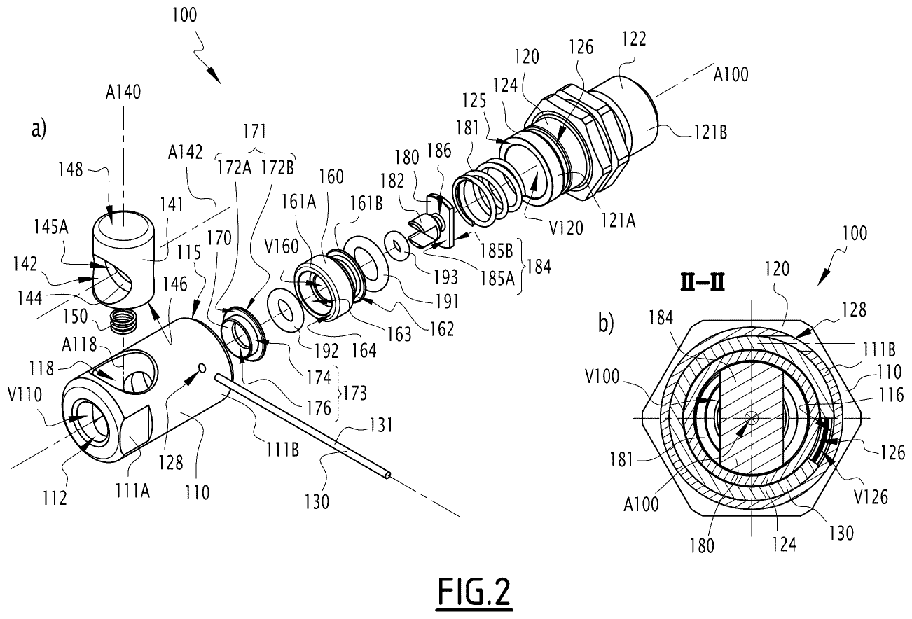

In the first embodiment, the axial locking element 130 is a cylindrical ring 131, which is introduced into the locking space V126 through the hole 128. In FIG. 2 a), the ring 131 is shown before being introduced into the hole 128, the ring 131 then having a rectilinear rod shape. During assembly, the ring 131 is forcefully introduced into the hole 128 and deforms, following the curvature of the locking space V126. In other words, the ring 131 is deformable. The ring 131 is preferably made of steel. Other materials are of course possible, like U.S. Pat. No. 5,209,262, which describes an axial locking element in nylon.

In FIG. 2 b), the ring 131 is shown received in the locking space V126. The axial locking element 130 is here entirely received in the locking space V126. Preferably, the hole 128 is sealed after the introduction of the locking element 130 to prevent the introduction of dust, preferably in a reversible manner to allow lubrication of the axial locking element 130. In a non-represented variant, a portion of the locking element 130 protrudes into the hole 128. Even if this is technically possible, it is not desirable for the ring to protrude outside the main body 110, as the user might injure themselves when handling the female element 100.

Thus, in general, the locking element 130 is at least partially housed in the external circumferential groove 126 of the tubular portion 124 and at least partially in the internal groove 116 of the bore 114 of the main body 110, so that the main body 110 is rotatable and blocked in translation relative to the adapter 120.

The female element 100 also comprises a lock 140, which is intended to maintain the male fitting 10 in the connected position. The lock 140 is assembled to the distal portion 111A of the main body 110, the lock 140 being movable between:
a locking position, wherein, when the male fitting 10 is received in the distal mouth 112 in the connected position, the lock 140 cooperates with the collar 22 to maintain the male fitting in the connected position, as illustrated in FIG. 3, and
an unlocking position, wherein the lock 140 releases the collar 22 and does not oppose the withdrawal of the male fitting 10 from the main body 110.

In the illustrated example, the lock 140 is partially received in the first passage V110. The main body 110 has an orifice 118, which extends along a locking axis A118, which is here a radial axis to the longitudinal axis A100. The first passage V110 opens from the main body through the orifice 118. The orifice 118 thus provides a housing for the lock 140. The orifice 118 is blind, the orifice 118 having a bottom 119.

In the illustrated example, the lock 140 has a generally cylindrical shape with a circular section and extends along a lock axis A140. When the lock 140 is received in the orifice 118, the lock axis A140 is coincident with the locking axis A118. The lock 140 is then guided in translation relative to the main body 110, the locking and unlocking positions being two axial positions of the lock 140 along the locking axis A118.

The lock 140 comprises a locking portion 141, which has an opening 142, which is provided through the locking portion 141 along an opening axis A142 orthogonal to the lock axis A140. When the female element 100 is assembled, in a configuration of use, the locking portion 141 is received in the first passage V110, the opening 142 of the lock 140 forming a portion of the first passage V110. The opening axis A142 is then parallel to the longitudinal axis A100. The opening 142 of the lock 140 is able to receive the male fitting 10. In the connected configuration of the connector R, the distal part 14 of the male fitting 10 passes through the lock 140 through the opening 142 of the lock 140, the collar 22 being located in the opening 142 of the lock 140.

The lock 140 here comprises a tooth 144, which is provided in projection in the opening 142 of the lock 140 and which is configured to cooperate with the collar 22 when the male fitting is in the connected position. The tooth 144 has a distal face 145A, which is here a conical face oriented towards the distal opening 112 of the main body 110, and a proximal face called locking face 145B, which is an axial face, i.e., a face carried by a plane perpendicular to the longitudinal axis A100. The locking face 145B is oriented towards the proximal side of the main body 110.

When the lock 140 is in the locking position and the male fitting 10 is in the connected position, the locking face 145B is located opposite the retaining face 22B of the collar 22, preventing the male fitting 10 from being moved away from the female element 100, as illustrated in FIG. 3. In other words, the locking face 145B is able to penetrate behind the collar 22 of the male fitting 10.

The female element here also comprises a return member 150, which is configured to return the lock 140 from its unlocking position to its locking position. The return member 150 is here a compression spring, which is placed between the locking portion 141 of the lock and the bottom 119 of the orifice 118, the return member 150 acting, by elastic return, to return the lock to its locking position. More precisely, the return member 150 is placed between a lower face 146 of the locking portion 141 and the bottom 119.

The lock 140 provides an actuation surface 148, which is a surface accessible from the outside of the female element 100 and which is intended for a user to be able to move the lock 140 from the locking position to the unlocking position, against the return member 150. In the illustrated example, the actuation surface 148 is a surface opposite the lower face 146. The actuation surface 148 here has a normal generally perpendicular to the longitudinal axis A100. In other words, the actuation surface 148 is a radial surface, oriented centrifugally to the longitudinal axis A100.

The female element 100 also comprises a seal support 160. The seal support 160 is received in the internal channel V100 and provides an internal passage V160. The seal support 160 is located on a proximal side of the lock 140, the internal passage V160 being configured to receive the distal part 14 of the male fitting 10 in the connected position.

The seal support 160 advantageously has a shape of revolution around the longitudinal axis A100. In the first embodiment, the seal support 160 is received in the internal channel V100 being free in rotation relative to the main body 110 of the female element 100 in an assembled configuration. The seal support 160 generally has an annular shape, more precisely a shape of revolution around the longitudinal axis A100. Preferably, the seal support 160 is made of synthetic polymer material, and preferably manufactured by hot injection.

The seal support 160 comprises a distal part 161A and a proximal part 161B. The proximal part 161B, which is configured to be received in the tubular portion 124, comprises an external surface, i.e., oriented opposite the longitudinal axis A100, which has a first external diameter. An internal diameter of the tubular portion 124 is greater than or equal to the first external diameter of the proximal part 161B of the seal support 160.

The seal support 160 comprises a first groove 162, which is located opposite, of the tubular portion 124, on the internal side. The first groove 162 is here provided, recessed, on the external surface of the proximal part 161B of the seal support 160. In other words, the proximal part 161B of the seal support 160 is received in the second passage V120 of the adapter, more precisely in the tubular portion 124.

The first groove 162 is intended to receive a first seal 191. The first groove 162 is an external circumferential groove. It is considered that the first seal 191 belongs to the seal support 160. The first seal 191 is interposed between the seal support 160 and an inner surface of the tubular portion 124 of the adapter 120, to ensure a seal between the seal support 160 and the adapter 120.

The seal support 160 provides a second groove 163, which is provided in the internal passage V160 of the seal support 160. The second groove 163 is thus an internal groove. The second groove 163 is here provided in an internal face of the distal part 161A of the seal support 160. In the first embodiment, the second groove 163 is an open groove, i.e., the second groove is partially open on one side, here towards the distal side of the seal support 160. The second groove 163 is intended to receive a second seal 192. It is considered that the second seal 192 belongs to the seal support 160. The second seal 192 is intended to cooperate with the first cylindrical part 20 of the distal part 14 of the male fitting 10, when the male fitting 10 is in the connected position, to prevent fluid passages between the seal support 160 and the male fitting 10.

Thus, thanks to the seal support 160, which carries the first and second seals 191 and 192, the seal between the adapter 120, the seal support 160, and the male fitting 10 in the connected position is ensured.

Advantageously, the seal support 160 comprises, on the distal side of the first groove 162, an intermediate part 161C which extends, on the distal side, beyond the end surface 125 of the tubular portion 124. The intermediate part 161C has a second external diameter, which is larger than the first external diameter of the proximal part 161B of the seal support 160. In other words, the intermediate part 161C forms an annular projection relative to the proximal part 161B. In particular, the second external diameter of the intermediate part 161C is larger than the internal diameter of the tubular portion 124, but smaller than the second internal diameter of the second cylindrical portion 117B of the bore 114. In the assembled configuration of the female element 100, the intermediate part 161C is housed in the second cylindrical portion 117B of the bore 114. Thus, the axial movements of the seal support 160 relative to the rest of the female element 100 are limited. The assembly of the seal support 160 is simple, as the seal support 160 is received in the second cylindrical portion 117B of the bore 114 and held by the distal part 124 of the adapter 120.

The female connector 100 comprises a stop washer 170, which is received in the first passage V110 between the lock 140 and the seal support 160. The stop washer 170 is configured to keep the lock 140 captive in the orifice 118.

In the first embodiment of the invention, the seal support 160 and the stop washer 170 form two distinct pieces.

The stop washer 170 comprises:
a proximal wall 171, which here has a ring shape centered on the longitudinal axis A100, the proximal wall comprising a distal face 172A, which is located opposite the stop wall 117D of the bore 114 and by which the stop washer 170 is axially supported against the stop wall 117D, and a proximal face 172B, which is located opposite a distal wall of the seal support 160.
an extension 173, which is provided in projection from the proximal wall 171 and which extends, beyond the third cylindrical portion 117C, into the orifice 118. In particular, the extension 173 extends into the opening 142 of the lock 140, so as to center the stop washer 173 in the third cylindrical portion 117C.

In the illustrated example, the proximal wall 171 cooperates with the seal support 160, the proximal wall 171 forming a third side in addition to the two sides of the open second groove 163. In other words, the second seal 192 is housed in a groove, delimited on the one hand by the open second groove 163 and, on the other hand, by the proximal wall 171 of the stop washer 170. When the connector is assembled, the stop washer 170 is axially supported against a distal wall 164 of the seal support 160.

The extension 173 here generally has a shape of revolution around the longitudinal axis A100, with here a generally triangular section in a plane containing the longitudinal axis A100. The extension 173 provides:
a protrusion 174, which extends into the opening 142 of the lock 140 and is intended to allow the movements of the lock 140 between the locking position and the unlocking position, while preventing movements beyond the locking position. In other words, the extension 173 is configured to stop the translation of the lock 140 in its locking position.
a guide surface 176, which is intended to guide the end of the male fitting 10 from the opening 142 of the lock 140 to the internal passage V160 of the seal support 160.

The guide surface 176 here has a frustoconical shape, which converges towards the proximal side of the female element 100. The stop washer is preferably made of metal, to resist the friction of the male fitting 10 on the guide surface 176 during connection or disconnection movements.

The female connector 100 also comprises a valve 180, which is received in the internal channel V100 and is movable in translation along the longitudinal axis A100 between:
a forward position, wherein the valve closes the internal channel V100, and
a rearward position, wherein the fluid flow through the internal channel V100 is not prevented.

The female connector 100 comprises a valve spring 181, which is configured to return the valve 180 from its rearward position to its forward position. The valve 180 is configured to be pushed into the rearward position, against the valve spring 181, by the end 16 of the male fitting 10 in the connected position.

The valve 180 is advantageously arranged on a side opposite the distal mouth 112 of the main body 110 relative to the second seal 192, in other words on a rear side of the second seal 192. The valve 180 comprises:
a distal part 182, which is received in the internal passage V160 of the seal support 160 when the valve 180 is in the closed position, and by means of which the valve is pushed into the open position by the end 16 of the male fitting 10 in the connected position, and
an axial stop 184, which extends radially to the longitudinal axis A100, and which has a front face 185A, which is axially supported against the seal support 160 when the valve 180 is in the closed position, the axial stop 184 having a rear face 185B, opposite the front face 185A.

In the illustrated example, the distal part 182 of the valve 180 extends in projection from the axial stop 184, the valve 180 providing a third groove 186 intended to receive a third seal 193. In the forward position of the valve, the third seal 193 is interposed between the valve and the seal support 160, the internal passage V160 of the seal support 160 being then sealed. The valve spring 181 is arranged between the rear face 185B of the axial stop 184 and the adapter 120. When the fluidic connector is disconnected, the return force of the valve spring 181 is transmitted to the main body 110 and applies between the locking element 130 and the adapter 120. This return force, whose value is well determined and stable throughout the life of the female element 100, ensures a resistant torque when the user rotates the main body 110 relative to the adapter 120.

The assembly of the female element 100 is now described.

It is considered that all the parts of the female element 100 are initially separated, as illustrated in FIG. 2 a). The assembly of the female element 100 includes the following steps:
Placing the lock spring 150 at the bottom 119 of the orifice 118 provided in the main body 110, then
Inserting the lock 140 into the orifice 118, so as to compress the lock spring 150, then
Placing the stop washer 170 by passing through the bore 114, so as to hold the lock 140, then
Inserting the seal support 160 into the main body 110 by passing through the bore 114, the first and second seals 191 and 192 being previously placed in the first groove 162 and in the second groove 163, then
Inserting the valve 180 into the main body 110 by passing through the bore 114, the third seal 193 being previously placed in the third groove 186, the distal part 182 of the valve 180 being introduced into the internal passage V160 of the seal support 160,
Placing the valve spring 181 in the tubular part 124 of the distal part 121A of the adapter 120, then
Fitting the tubular part 124 into the bore 114, the valve spring 181 being jointly supported against the rear face 185B of the axial stop 184 and the adapter 120, then
Placing the axial locking element 130 in the locking space V126, by passing through the hole 128.

The coupling sequence of the female element 100 and the male fitting 10 is now described.

To couple the female element 100 of connector R and the male fitting 10, initially the end 16 of the male fitting 10 is positioned opposite the distal mouth 112 of the female element, the longitudinal axis A100 of the female element 100 being aligned with the main axis A10 of the male fitting 10, as illustrated in FIG. 1. Then, the female element 100 is brought closer to the male fitting 10.

During the approach:
the end 16 of the male fitting 10 comes into contact with the guide surface 176, so as to keep the male fitting 10 aligned on the longitudinal axis A100. Then the first cylindrical part 20 cooperates with the second seal 192, ensuring the seal between the male fitting 10 and the seal support 160.
The conical first face 22A of the collar 22 comes into contact with the tooth 144 of the lock 140, pushing the lock 140 from its locking position to its unlocking position,
while the end 16 of the male fitting 10 comes into contact with the valve 180, moving the valve 180 to its rearward position. The internal passage V10 is then in fluid communication with the internal channel V100.
When the tooth 144 of the lock 140 arrives behind the collar 22 of the male fitting 10, the lock 140 returns to its locking position under the effect of the lock spring 150. The female element 100 and the male fitting 10 are then connected to each other, the connector R being in the connected configuration, wherein the fluid passage is free, as illustrated in FIG. 3.

It is possible to change the orientation of the main body 110 relative to the adapter 120, without having to make the first, second, and third seals 191, 192, and 193 slide. In other words, the rotation of the main body 110 relative to the adapter 120 does not cause wear or friction to the seals 191/192/193.

When the female element 10 is not connected to the male fitting 10, the seal of the fluid line is ensured by the first seal 191 of the seal support 160 and the third seal 193 of the valve 180. Due to the chosen construction, it is possible to reorient the main body 110 relative to the adapter 120 without rubbing the two seals 191/193, i.e., avoiding any wear.

The disconnection sequence of the female element 100 and the male fitting 10 is now described.

While the connector R is initially in the connected configuration, to disconnect, it is necessary to actuate the lock 140 by pressing on the actuation face 148. The tooth 144 of the lock 140 then disengages from the collar 22 of the male fitting 10. It is then possible to move the male fitting 10 away from the female element 100 along the longitudinal axis A100.

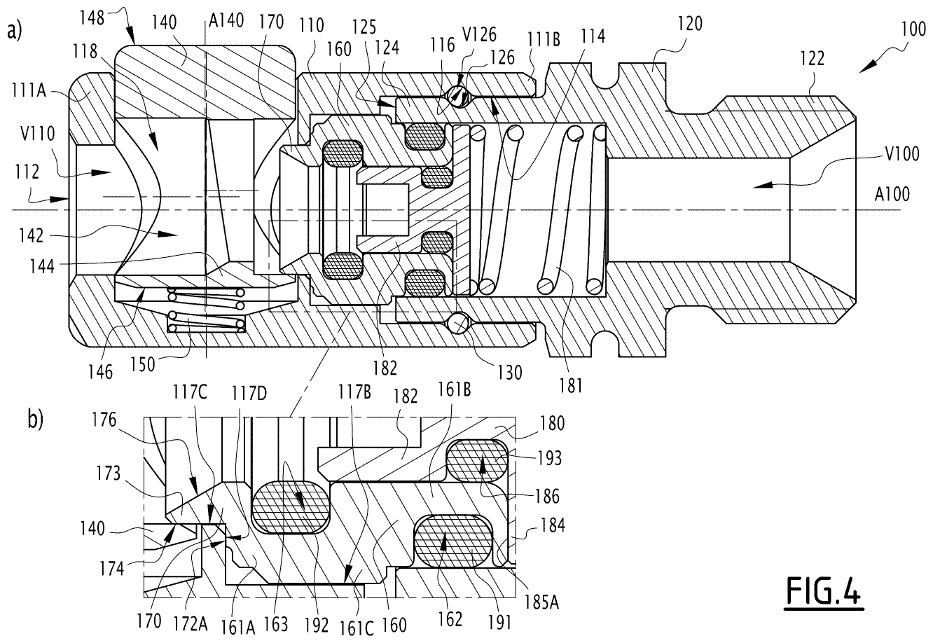

Alternative embodiments of the invention are illustrated in FIGS. 4 to 8. In the alternative embodiments of the invention, the elements analogous to those of the other embodiments bear the same references and function in the same way. In the following, the differences between each embodiment and the previous one(s) are mainly described. In relation to the alternative embodiments of the invention, if a reference is mentioned in the description without being shown in a figure, or if this reference is shown in a figure without being mentioned in the description, this reference designates the same element as the one bearing the same reference in the first embodiment.

A second embodiment of the invention is shown in FIG. 4. One of the main differences of the second embodiment with the previous embodiment is that the seal support 160 and the stop washer 170 form a single piece. The seal support 160 and the stop washer 170 are, for example, made of synthetic polymer material and are produced by hot injection. Alternatively, the seal support 160 and the stop washer 170 are made of metal, for example, by machining.

The assembly of the female connector element is similar to that of the first embodiment but includes one less step.

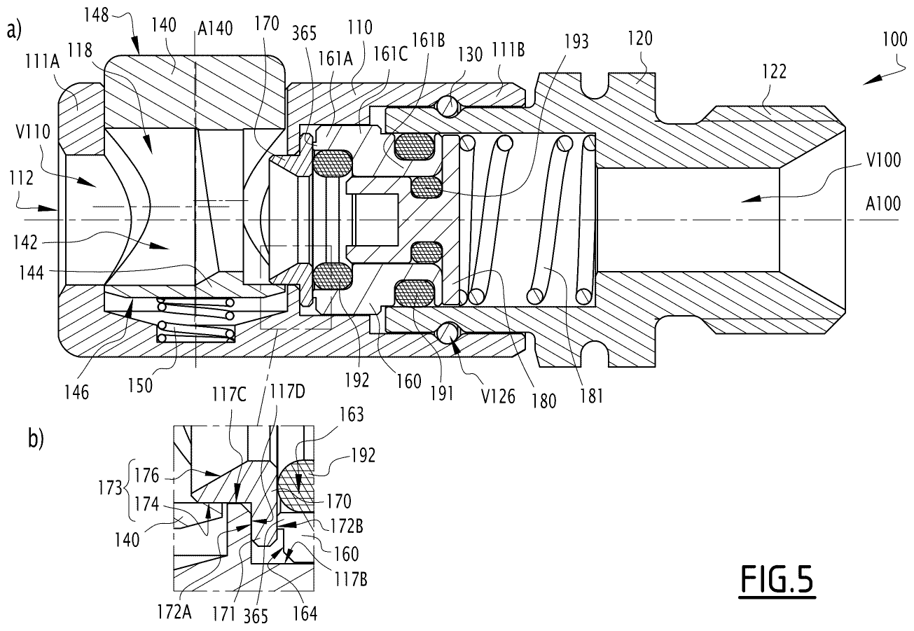

A third embodiment of the invention is shown in FIG. 5. In the third embodiment, the seal support 160 and the stop washer 170 form two distinct pieces, one of the main differences of the third embodiment with the first embodiment being that the seal support 160 comprises a circular boss 365, which is provided on the distal wall 164 of the seal support 160.

The stop washer 170 is axially supported against the distal wall 164 of the seal support by means of the circular boss 365.

The contact surface between the stop washer 170 and the seal support 160 is reduced, which allows the friction torque between the seal support 160 and the stop washer 170 to be lowered. As a result, the sliding caused by the rotation of the main body 110 relative to the adapter 120 occurs preferentially between the stop washer 170 and the seal support 160, and not between the stop washer 170 and the main body 110 or between the seal support 160 and the valve 180 or between the seal support 160 and the adapter 120. The risk that the first seal 191 of the seal support 160 rubs when orienting the main body 110 relative to the adapter 120 is thus reduced. In a non-illustrated alternative, the circular boss is provided on the proximal face 172B of the stop washer 170, the proximal face 172B being located opposite the distal wall 164 of the seal support 160.

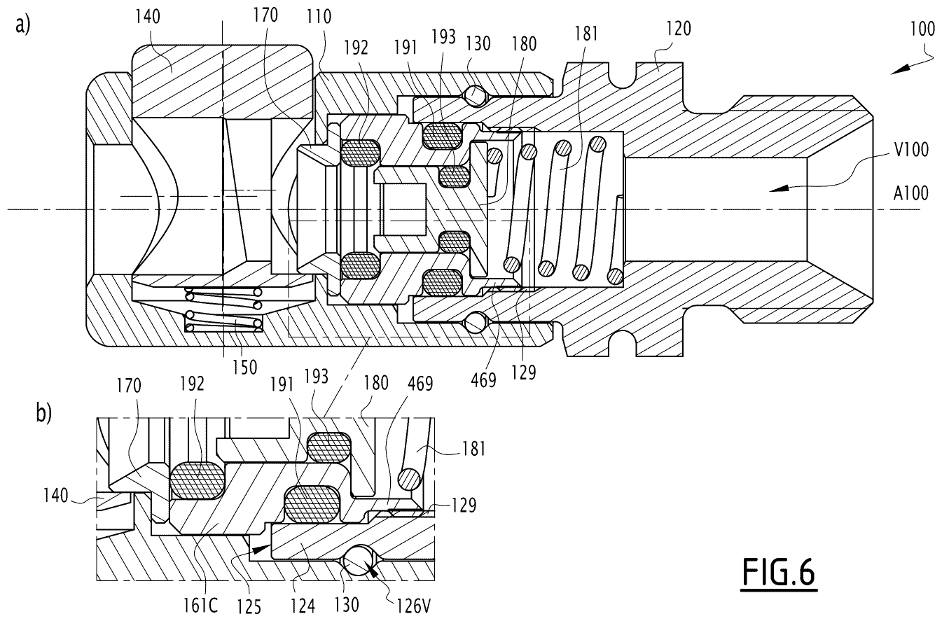

A fourth embodiment of the invention is shown in FIG. 6. One of the main differences of the fourth embodiment with the previous embodiments is that the seal support 160 is screwed into an internal surface of the distal part of the adapter 120.

The seal support 160 here comprises a threaded portion 469, which is located on the proximal side of the first seal 191, and which cooperates with a threaded portion 129 of the internal wall of the tubular portion 124 of the distal part 121A of the adapter 120. In other words, while the seal support 160 is free in rotation relative to the main body 110, the seal support 160 is blocked in rotation relative to the adapter 120. This solution is more expensive than the previous ones but guarantees that when orienting the main body 110 relative to the adapter 120, the first seal 191 of the seal support 160 does not rub.

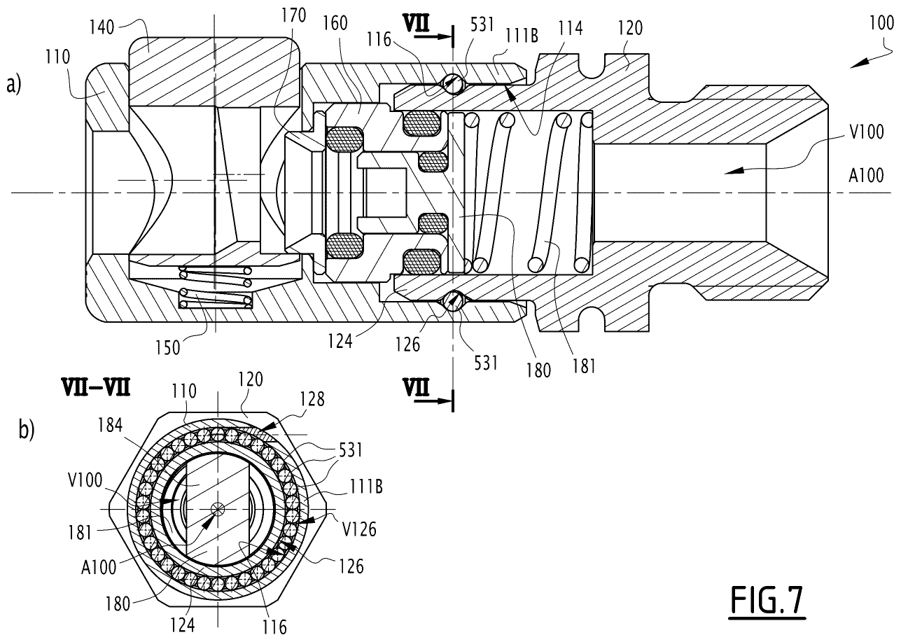

A fifth embodiment of the invention is shown in FIG. 7. One of the main differences of the fifth embodiment with the previous embodiments is that the locking element 130 is a plurality of balls 531. The balls 531 are introduced into the locking space V126 through the hole 128, which is sealed after assembly. Thus, the plurality of balls 531 makes it possible, like a ball bearing, to reduce friction between the main body 110 and the adapter 120, which facilitates orientation and reduces wear throughout the life of the female element 100, contributing to the longevity of the female element 100 and the stability of the rotation torque of the main body 110 relative to the shutter 120.

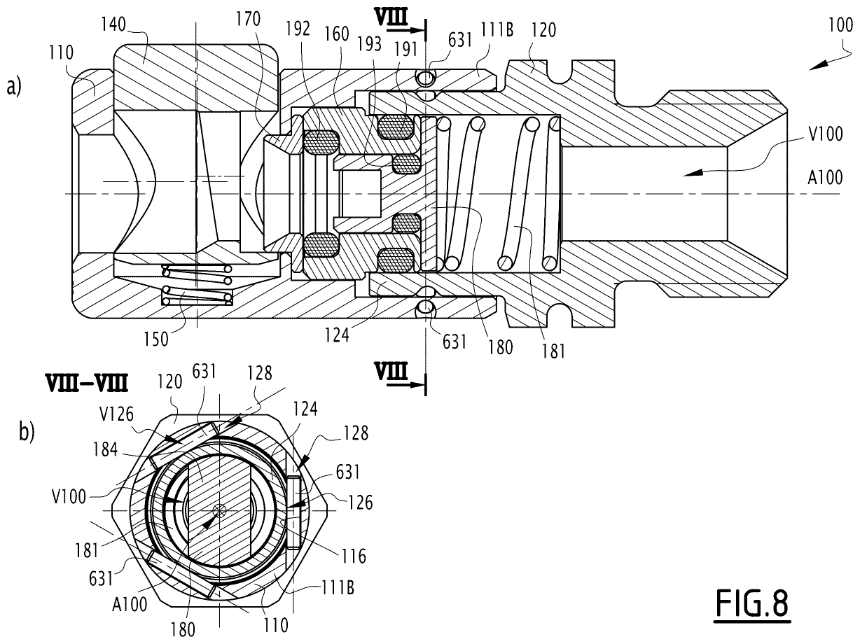

A sixth embodiment of the invention is shown in FIG. 8. One of the main differences of the sixth embodiment with the other embodiments is that the proximal portion 111B of the main body 110 comprises a plurality of holes 128, which are each intended to receive a respective pin 631. In the assembled configuration of the female element 100, the holes 128 connect the external circumferential groove 126 to the outside of the main body 110, also the portions of the holes 128 that open partially into the bore 114 and are opposite the external circumferential groove 126 form the internal groove 116. In other words, the set of pin passage holes 128 together form the internal groove 116.

The locking space V126 is formed by the union of the external circumferential groove 126 and each portion of the hole 128 opening opposite. The holes 128 are advantageously provided orthoradially to the longitudinal axis A100.

The locking element 130 is here formed by a plurality of pins 631, each pin 631 being introduced into the locking space V126 defined between the external circumferential groove 126 and the internal groove 116 through the corresponding passage hole 128. The pins 631 are held in place in the respective hole 128 by clamping, conferring robustness to the female element 100. The pins 631 are advantageously removable, which allows the female element 100 to be disassembled, for example, for maintenance purposes.

The embodiments and variants mentioned above can be combined with each other to generate new embodiments of the invention.

What is claimed is:

1. A female element of fluidic connector, the female element being intended to be connected to a male fitting, the male fitting comprising an end with a first cylindrical part and a locking collar, the female element comprising:
a main body, which provides a first passage extending along a longitudinal axis, the main body comprising a distal portion and a proximal portion, which are aligned along the longitudinal axis, a first passage opening from the distal portion through a distal mouth, the main body being configured to receive the male fitting in the first passage through the distal mouth,
a lock, which is assembled to the distal portion and is movable between:
a locking position, wherein, when the male fitting is received in the distal mouth in the connected position, the lock cooperates with the collar to maintain the male fitting in the connected position, and
an unlocking position, wherein the lock releases the collar and does not oppose withdrawal of the male fitting from the main body,
a return member, which is configured to return the lock from its unlocking position to its locking position,
an adapter, which is traversed by a second passage, and which comprises:
a proximal part, from which the second passage opens and by which the adapter is able to be fluidically connected to a pipeline, and
a distal part, from which the second passage opens and by which the adapter is able to be assembled to the proximal portion of the main body, so that the second passage is in communication with the first passage, the first passage and the second passage together forming an internal channel of the female element,
wherein:
the distal part of the adapter includes a tubular portion, which has a cylindrical shape wherein an external circumferential groove is provided,
the proximal portion of the main body includes a bore:
which has a complementary shape to the tubular portion and is configured to receive the tubular portion of the adapter in an assembled configuration of the female element, and
wherein an internal groove is provided, which is located opposite the external circumferential groove when the female element is in an assembled configuration, the external circumferential groove and the internal groove opposite forming together a locking space,
the female element also comprises an axial locking element, which is partially housed in the external circumferential groove of the tubular portion of the adapter and partially in the internal groove of the bore of the proximal portion of the main body, so that the main body is rotatable relative to the adapter,
the female element also comprises:
a seal support, which is received in the internal channel, and which provides an internal passage configured to receive the cylindrical part of the male fitting,
a first seal, which is interposed between the seal support and an inner surface of the tubular portion of the adapter, to ensure a seal between the seal support and the adapter,
a second seal, which is arranged in the internal passage and is intended to ensure a seal between the seal support and the male fitting in the connected position,
the seal support is received in the internal channel being free in rotation relative to the main body of the female element in an assembled configuration.

2. The female element according to claim 1, wherein:
the bore of the proximal portion comprises:
a first cylindrical portion, which has a first internal diameter and is intended to receive the tubular portion of the adapter,
a second cylindrical portion, which has a second internal diameter, the second internal diameter being smaller than the first internal diameter,
a third cylindrical portion, which has a third internal diameter, the third internal diameter being smaller than the second internal diameter,
a stop wall, which extends in a plane perpendicular to the longitudinal axis between the second cylindrical portion and the third cylindrical portion,
the seal support comprises:
a proximal part, which has a first external diameter and wherein a first groove for receiving the first seal is provided, and
an intermediate part, which has a second external diameter, the second external diameter being larger than the first external diameter, the intermediate part being housed in the second cylindrical portion of the bore.

3. The female element according to claim 1, wherein:
the distal portion of the main body provides an orifice, which extends along a locking axis radial to the longitudinal axis, and which opens into the first passage,
the lock comprises a locking portion, which is received in the orifice and wherein an opening is provided to receive the male fitting,
the lock is movable in translation relative to the main body along the locking axis, the locking position and the unlocking position being two axial positions along the locking axis,
the female element comprises a stop washer, which is received in the internal channel between the lock and the seal support, the stop washer comprising:
a protrusion, which extends into the opening of the lock and is intended to allow movements of the lock between the locking position and the unlocking position, while preventing movements beyond the locking position and,
a guide surface, which is intended to guide the first cylindrical part of the male fitting from the opening of the lock to the internal passage of the seal support.

4. The female element according to claim 3, wherein:
the bore of the proximal portion of the main body comprises:
a first cylindrical portion, which has a first internal diameter and is intended to receive the tubular portion of the adapter,
a second cylindrical portion, which has a second internal diameter, the second internal diameter being smaller than the first internal diameter,
a third cylindrical portion, which has a third internal diameter, the third internal diameter being smaller than the second internal diameter,
a stop wall, which extends in a plane perpendicular to the longitudinal axis between the second cylindrical portion and the third cylindrical portion,
the stop washer is axially supported against the stop wall and centered in the third cylindrical portion.

5. The female element according to claim 3, wherein:
the seal support and the stop washer form a single piece.

6. The female element according to claim 3, wherein:
the seal support and the stop washer form two distinct pieces,
the seal support comprises a distal wall, which is oriented towards the stop washer and on which a circular boss is provided,
the stop washer is axially supported against the distal wall of the seal support by means of the circular boss.

7. The female element according to claim 3, wherein:
the seal support and the stop washer form two distinct pieces,
the seal support comprises a distal wall, which is oriented towards the stop washer,
the stop washer comprises a proximal face, on which a circular boss is provided in axial support against the distal wall of the seal support.

8. The female element according to claim 1, wherein the female element comprises:
a valve, which is received in the internal channel and is movable in translation along the longitudinal axis between:
a forward position, wherein the valve closes fluid flow through the internal channel, and
a rearward position, wherein the fluid flow through the internal channel is not prevented,
a valve spring, which is configured to return the valve from the rearward position to the forward position, the valve being configured to be pushed into the rearward position, against the valve spring, by the end of the male fitting in the connected position.

9. The female element according to claim 8, wherein:
the valve is arranged on a side opposite the distal mouth of the main body relative to the second seal, the valve comprising:
a distal part, which is received in the internal passage of the seal support when the valve is in the closed position and by means of which the valve is pushed into the open position by the end of the male fitting in the connected position, and
an axial stop, which extends radially to the longitudinal axis and which has a front face, which is axially supported against the seal support when the valve is in the closed position, the axial stop having a rear face, opposite the front face,
the valve spring is arranged between the rear face of the axial stop and the adapter.

10. The female element according to claim 1, wherein:
the seal support is screwed into an internal surface of the distal part of the adapter.

11. The female element according to claim 1, wherein:
the internal groove of the bore is an internal circumferential groove,
the locking element is a deformable ring, which is introduced into the locking space through a hole in the main body.

12. The female element according to claim 1, wherein:
the internal groove of the bore is an internal circumferential groove,
the locking element is a plurality of balls, which are introduced into the locking space through a hole in the main body, the hole being sealed after assembly.

13. The female element according to claim 1, wherein:
the bore of the main body comprises a plurality of holes, which are each intended for the passage of a respective pin, which are arranged orthoradially to the longitudinal axis and which open into the bore, a set of pin passage holes forming the internal groove,
the pins together form the locking element, each pin being introduced into the locking space through the corresponding passage hole.

14. A fluidic connector, comprising:
an instance of the female element according to claim 1, and
a male fitting, which comprises an end with a first cylindrical part and a locking collar,
wherein the male fitting is received in the connected position in the internal channel of the female element.
